(19) United States
(12) Patent Application Publication
(10) Pub. No.: US 2017/0371785 A1
(43) Pub. Date: Dec. 28, 2017

(54) Techniques for Write Commands to a Storage Device

(71) Applicant: Intel Corporation, Santa Clara, CA (US)

(72) Inventors: James A. Boyd, Hillsboro, OR (US); John W. Carroll, Gilbert, AZ (US); Sanjeev N. Trika, Portland, OR (US); Mark A. Schmisseur, (US)

(73) Assignee: Intel Corporation, Santa Clara, CA (US)

(21) Appl. No.: 15/195,783

(22) Filed: Jun. 28, 2016

(51) Int. Cl. G06F 12/0804

(52) U.S. Cl. CPC G06F 12/0804; G06F 2212/1024

(57) ABSTRACT

Examples include techniques for a write commands to one or more storage devices coupled with a host computing platform. In some examples, the write commands may be responsive to write requests from applications hosted or supported by the host computing platform. A tracking table is utilized by elements of the host computing platform and the one or more storage devices such that the write commands are completed by the one or more storage devices without a need for an interrupt response to elements of the host computing platform.

### TECHNICAL FIELD

Examples described herein are generally related to techniques for write commands or write operations to a storage device.

### BACKGROUND

Storage drivers implemented or supported by processing circuitry or processor elements (e.g., central processing units (CPUs)) of a host computing device or platform may be configured to process incoming write requests from elements such as applications hosted by the host computing device. The incoming write requests may be to one or more storage devices coupled with the host computing device.

### BRIEF DESCRIPTION OF THE DRAWINGS

FIG. 1 illustrates an example system.

FIG. 2 illustrates an example first tracking table.

FIG. 3 illustrates an example second tracking table.

FIG. 4 illustrates an example process.

FIG. 5 illustrates an example block diagram for a first apparatus.

FIG. 6 illustrates an example of a first logic flow.

FIG. 7 illustrates an example of a first storage medium.

FIG. 8 illustrates an example computing platform.

FIG. 9 illustrates an example block diagram for a second apparatus.

FIG. 10 illustrates an example of a second logic flow.

FIG. 11 illustrates an example of a second storage medium.

FIG. 12 illustrates an example storage device.

### DETAILED DESCRIPTION

As contemplated in the present disclosure, a storage driver implemented or supported by processing circuitry (e.g., a CPU) of a host computing device may be configured to process an incoming write request from one or more elements (e.g., applications) hosted by the host computing device. Typically, responsive to receiving the incoming write request from a requestor, the storage driver may (a) generate or issue a corresponding write request to one or more storage devices coupled with the host computing device, (b) wait for a corresponding interrupt that indicates a command completion for the write request and (c) return a completion status to the requestor following receipt of the interrupt, which may wake up a CPU, if placed in a sleep mode following the write request. Waiting for the corresponding interrupt may consume power. Waking the CPU to return the completion status to the request may also consume power. Power consumption for waiting and/or waking the CPU may be especially acute for some storage device configurations such as those used in redundant array of independent disks (RAID) that may include a storage driver issuing write requests to multiple storage devices. Multiple write requests to multiple storage devices may result in the storage driver waiting for each of these write requests to complete and facing differing delay times as well as multiple interrupts from the multiple storage devices.

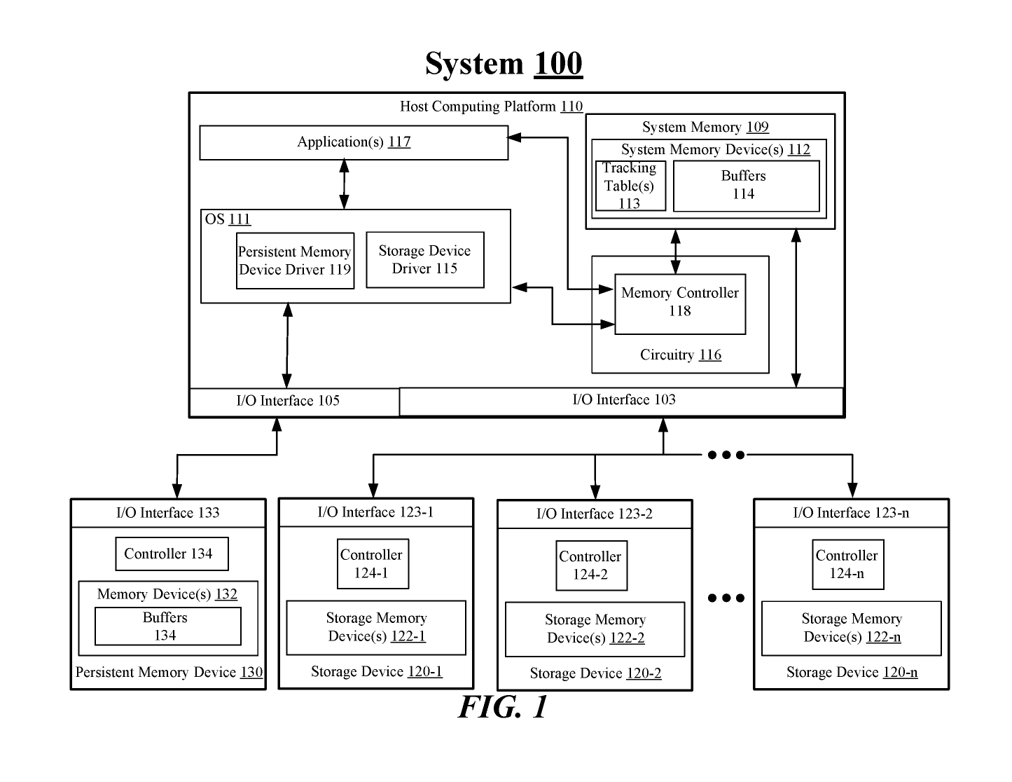

FIG. 1 illustrates an example system 100. In some examples, as shown in FIG. 1, system 100 includes a host computing platform 110 coupled with storage devices 120-1 to 120-n through input/output (I/O) interface 103 and respective I/O interfaces 123-1 to 123-n, where “n” is any positive whole integer >2. Also, as shown in FIG. 1, host computing platform 110 may couple with a persistent memory device 130 through I/O interface 105 and I/O interface 133. Also, as shown in FIG. 1, host computing platform 110 may include an OS 111, system memory device 109, circuitry 116 and one or more application(s) 117. For these examples, circuitry 116 may be capable of executing various functional elements of host computing platform 110 such as OS 111 and application(s) 117 that may be maintained, at least in part, within one or more system memory device(s) 112 of system memory 109. Circuitry 116 may include host processing circuitry or processing elements to include one or more CPUs and associated chipsets and/or controllers.

In some examples, host computing platform 110 may include, but is not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

According to some examples, system memory device(s) 112 of system memory 109 may store information and commands which may be used by circuitry 116 for processing information. Also, as shown in FIG. 1, circuitry 116 may include a memory controller 118. Memory controller 118 may be arranged to control access to data or information at least temporarily stored at system memory device(s) 112 by elements of host computing platform 110 (e.g., OS 111 or application(s) 117).

According to some examples, as shown in FIG. 1, OS 111 may include a storage device driver 115 and a persistent memory device driver 119. Storage device driver 115 may include logic and/or features capable of communication with respective elements of storage devices 120-1 to 120-n such as respective controller 124-1 to 124-n through I/O interface 103 and respective I/O interfaces 123-1 to 123-n to cause data to be stored to one or more respective storage memory device(s) 122-1 to 124-n. Persistent memory device driver 119 may include logic and/or features capable of communication with elements of persistent memory device 130 such as controller 134 through I/O interface 105 and I/O interface 133 to cause data to be at least temporarily stored to buffers 134 maintained at one or more memory device(s) 132.

In some examples, system memory device(s) 112 of system memory 109 may be arranged to store information for write commands in one or more tracking table(s) 113. The information for write commands may be initially placed in tracking table(s) 113 by logic and/or features of storage device driver 115 implemented by OS 111. According to some examples, the information for write commands may be placed by storage device driver 115 responsive to one or more write requests from elements of host computing platform 110 such as application(s) 117 to store data to one or more storage devices from among storage devices 120-1 to 120-n. The information for write commands placed in tracking table(s) 113 may include information for a WriteNoInterrupt command. The information for the WriteNoInterrupt command may indicate or point to one or more buffers where the data to be stored to the one or more storage devices is temporarily copied or stored prior to being stored to the one or more storage devices and may also include additional information such as status information. In some examples, the data may be temporarily stored to buffers 114 maintained at one or more system memory device(s) 112. In other examples, the data may be temporarily stored to buffers 134 maintained at one or more memory device(s) 132 at persistent memory device 130. As described more below, which buffers from among buffers 114 or 134 temporarily stores the data may be determined based on whether or not application(s) 117 permits volatile caching of data prior to storage to storage devices coupled with host computing platform 110.

According to some examples, the information for write commands placed in tracking table(s) 113 by storage device driver 115 responsive to write requests from application(s) 117 may be accessible to logic and/or features of a controller of a storage device such as controllers 124-1 to 124-n of storage devices 120-1 to 120-n via respective I/O interfaces 123-1 to 123-n and I/O interface 103. These I/O interfaces may enable elements of storage devices 120-1 to 120-n to directly access system memory device(s) such as system memory device(s) 112. For these examples, I/O interface 103 as well as I/O interfaces 123-1 to 123-n may be arranged as Peripheral Component Interconnect Express (PCIe) interfaces to couple elements of host computing platform 110 to elements of storage devices 120-1 to 120-n. In another example, the I/O interface 103 and I/O interfaces 123-1 to 123-n may be arranged as Non-Volatile Memory Express (NVMe) interfaces to couple elements of host computing platform 110 to elements of storage devices 120-1 to 120-n. For this other example, communication protocols may be utilized to communicate through the I/O interface 103 and I/O interfaces 123-1 to 123-n as described in industry standards or specifications (including progenies or variants) such as the Peripheral Component Interconnect (PCI) Express Base Specification, revision 3.1a, published in December 2015 (“PCI Express specification” or “PCIe specification”) and/or the Non-Volatile Memory Express (NVMe) Specification, revision 1.2a, published in October 2015 (“NVMe specification”).

In some examples, I/O interface 103 and respective I/O interfaces 123-1 to 123-n may be arranged as NVMe specification compliant interfaces. For these examples, one or more controllers of storage devices 120-1 to 120-n may access buffers 114 and tracking table(s) 113 through I/O interface 103 and respective I/O interfaces 123-1 to 123-n using communication protocols compliant with the NVMe specification. Access to buffers 114 and tracking table(s) 113 may be responsive to an issued write request from storage device driver 115 that may be a WriteNoInterrupt request. The WriteNoInterrupt request may include an indication of a buffer location in buffers 114 for WriteNoInterrupt command information and associated data to be stored to the one or more storage devices 120-1 to 120-n. The WriteNoInterrupt command information may include a tracking table location to locate a tracking table included in tracking table(s) 113 maintained in the one or more system memory devices of system memory 109. The WriteNoInterrupt request may be responsive to a write request by one or more application(s) 117. The WriteNoInterrupt request, for example, may be accepted by one or more controllers of storage devices 120-1 to 120-n via a write mechanism such as a doorbell mechanism.

According to some examples, application(s) 117 supported by host computing platform 110 may be designed to operate as client applications. In other words, application(s) 117 may be designed to operate as part of a standalone host computing platform. For these examples, application(s) 117 may permit for volatile caching of data to be written to storage devices 120-1 to 120-n by permitting data to be temporarily copied or stored to buffers 114 maintained at system memory device(s) 112 of system memory 109 before being written or stored to storage devices 120-1 to 120-n. In some examples, storage device driver 115 may cause the data to be stored to one or more buffers of buffers 114 responsive to a write request from application(s) 117 permitting volatile caching. Storage device driver 115 may then include information in tracking table(s) 113 to point to the one or more buffers of buffers 114 to facilitate tracking of completion of write operation(s) for storing the data to the one or more storage devices 120-1 to 120-n. Controllers of storage devices 120-1 to 120-n may access tracking table(s) 113 to indicate completion of write operation(s) and/or status information related to successfully/unsuccessfully storing the data.

In some examples, memory device(s) 132 included in persistent memory device 130 may be characterized as a way to store data (e.g., data structures) such that the data may continue to be accessible using memory instructions or memory application programming interfaces (APIs) even after the process that created or last modified the data ends. For these examples, memory device(s) 132 may be accessed in a similar manner to types of memory (e.g., volatile memory) included in system memory device(s) 112 of host computing platform 110, but memory device(s) 132 may retain stored data across power loss in a similar manner to types of memory included in storage devices 120-1 to 120-n (e.g., hard disk drives or solid state drives). Persistent memory capabilities for persistent memory device 130 may extend beyond an ability to retain stored data across power loss to memory device(s) 132 once power is restored to memory device(s) 132. For example, key metadata, such as page table entries or other constructs that translate virtual addresses to physical addresses also may be retained across power loss.

According to some examples, application(s) 117 supported by host computing platform 110 may be designed to operate as datacenter applications. In other words, application(s) 117 may be designed to operate as part of a composite or multitude of host computing platforms included in one or more datacenters. For these examples, application(s) 117 may not permit or prohibits volatile caching of data to be written to storage devices 120-1 to 120-n. Not permitting volatile caching may be due to, but is not limited to, strict reliability and/or availability requirements that does not allow for volatile caching due to a possible loss of power and a consequent unacceptable loss of at least some data.

In some examples, where volatile caching is not permitted, buffers 134 maintained at memory device(s) 132 at persistent memory device 130 may be used to temporarily store data. For these examples, storage device driver 115 may cause the data to be copied or stored to one or more buffers of buffers 134 responsive to a write request from application(s) 117 that do not permit volatile caching. Storage device driver 115 may then include information in tracking table(s) 113 to point to the one or more buffers of buffers 134 to facilitate tracking of completion of write operation(s) for storing the data to the one or more storage devices 120-1 to 120-n. Controllers of storage devices 120-1 to 120-n may access tracking table(s) 113 to indicate completion of the storing of the data to storage devices 120-1 to 120-n and/or status information related to the storing of the data.

According to some examples, persistent memory device 130 may not be coupled with host computing platform 110 or has become inoperable. For these examples, application(s) 117 may not permit volatile caching. As a result of not having available persistent memory, a WriteNoInterrupt command may be disabled. In other words, storage device driver 115 may send a write request that results in a write command having no tracking table(s) 113 information and storage device driver 115 may wait for sending an indication of completion of the write to storage devices 120-1 to 120-n until after controllers 124-1 to 124-n send an interrupt to storage device driver 115 to indicate the data has been stored.

According to some other examples where persistent memory device 130 may not be coupled with host computing platform 110, some applications from among applications(s) 117 may permit volatile caching while other applications from among application(s) 117 do not permit volatile caching. In an alternative to this example, a single application from among application(s) 117 may permit volatile caching for a first type of write request, but does not permit volatile caching for a second type of write request. For either this example or its alternative, an Interrupt command for instances where volatile caching is not permitted may be interleaved with WriteNoInterrupt commands for instances where volatile caching is permitted. In other words, examples are not limited to using all Interrupt commands or all WriteNoInterrupt commands. In some examples, combinations of these types of commands are contemplated.

In some examples, I/O interface 105, I/O interface 133 of persistent memory device 130 and I/O interfaces 123-1 to 123-n of storage devices 120-1 to 120-n may be arranged as NVMe specification compliant interfaces. For these examples, persistent memory device driver 119, storage device driver 115 and controllers 124-1 to 124-n may use communication protocols compliant with the NVMe specification to coordinate storing of data temporarily maintained in buffers 134 to one or more storage memory devices 122-1 to 122-n of respective one or more storage devices 120-1 to 120-n.

According to some examples, storage device 120-1 to 120-n may be arranged to support redundant array of independent disks (RAID). In some examples, data from application(s) 117 may be distributed across storage devices in various ways referred to as RAID levels. A given RAID level may depend on a desired level of redundancy and performance. Various RAID levels have separate schemes that each provides a different balance between reliability, availability, performance and capacity that may include storing data to one or multiple storage devices 120-1 to 120-n. RAID levels may include, but are not limited to RAID levels 0-6.

In some examples, system memory device(s) 112 of system memory 109 may include one or more chips or dies having volatile types of memory such as random access memory (RAM), dynamic RAM (D-RAM), double data rate synchronous dynamic RAM (DDR SDRAM), static RAM (SRAM,) thyristor RAM (T-RAM) or zero-capacitor RAM (Z-RAM). However, examples are not limited in this manner, and in some instances, system memory device(s) 112 may include non-volatile types of memory, including, but not limited to, NAND flash memory, NOR flash memory, single or multi-level phase change memory (PCM), resistive memory, nanowire memory, ferroelectric transistor random access memory (FeTRAM), silicon-oxide-nitride-oxide-silicon (SONOS) memory, magnetoresistive random access memory (MRAM) memory that incorporates memristor technology, or spin transfer torque MRAM (STT-MRAM).

According to some examples, storage memory device(s) 122 may include one or more chips or dies that may individually include one or more types of non-volatile memory to include, but not limited to, NAND flash memory, NOR flash memory, 3-D cross-point memory, ferroelectric memory, SONOS memory, ferroelectric polymer memory, FeTRAM, FeRAM, ovonic memory, nanowire, EEPROM, phase change memory, memristors or STT-MRAM, ovonic memory, nanowire or electrically erasable programmable read-only memory (EEPROM). For these examples, one or more storage devices 120-1 to 120-n may be arranged or configured as solid-state drives (SSDs). Examples are not limited to storage devices arranged or configured as SSDs, other storage devices such as a hard disk drive (HDD) are contemplated. In these instances, one or more storage memory device (s) 122-1 to 122-n may include one or more platters or rotating disks having a magnetic material to store data.

In some examples, memory device(s) 132 at persistent memory device 130 may be composed of one or more memory devices or dies which may include various types of volatile and/or non-volatile memory. Volatile memory may include, but is not limited to, RAM, D-RAM, DDR SDRAM, SRAM, T-RAM or Z-RAM. Non-volatile memory may include, but is not limited to, non-volatile types of memory such as 3-D cross-point memory that may be byte or block addressable. These block addressable or byte addressable non-volatile types of memory may include, but are not limited to, memory that uses chalcogenide phase change material (e.g., chalcogenide glass), multi-threshold level NAND flash memory, NOR flash memory, single or multi-level phase change memory, resistive memory, nanowire memory, FeTRAM, MRAM, memory that incorporates memristor technology, or STT-MRAM, or a combination of any of the above, or other non-volatile memory types.

According to some examples, the one or more memory devices included in persistent memory device(s) 132 and/or system memory device(s) 112 may be designed to operate in accordance with various memory technologies. The various memory technologies may include, but are not limited to, DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WI02 (Wide I/O 2 (WideIO2), JESD229-2, originally published by JEDEC in August 2014), HBM (HIGH BANDWIDTH MEMORY DRAM, JESD235, originally published by JEDEC in October 2013), and/or other technologies based on derivatives or extensions of such specifications. The various memory technologies may also include memory technologies currently in development that may include, but are not limited to, DDR5 (DDR version 5, currently in discussion by JEDEC), LPDDR5 (LPDDR version 5, currently in discussion by JEDEC), HBM2 (HBM version 2, currently in discussion by JEDEC), and/or other new technologies based on derivatives or extensions of these developing memory technologies.

In some examples, the one or more memory devices of memory device(s) 132 or system memory device(s) 112 may be located on one or more dual in-line memory modules (DIMMs). These DIMMs may be designed to function as a registered DIMM (RDIMM), a load reduced DIMM (LRDIMM), a fully-buffered DIMM (FB-DIMM), an unbuffered DIMM (UDIMM) or a small outline (SODIMM). Examples are not limited to only these DIMM designs.

In some examples, memory devices of memory device(s) 132 or system memory device(s) 112 maintained on one or more DIMMs may include all or combinations of types of volatile or non-volatile memory. For example, memory devices of a first type of DIMM may include volatile memory on a front or first side and may include non-volatile memory on a back or second side. In other examples, a second type of DIMM may include combinations of non-volatile and volatile types of memory on either side of this second type of DIMM. In other examples, all memory devices on a given DIMM may be either volatile types of memory or non-volatile types of memory. In other examples, a third type of DIMM may include non-volatile memory and at least some volatile memory and this third type of DIMM may be referred to as a non-volatile DIMM (NVDIMM).

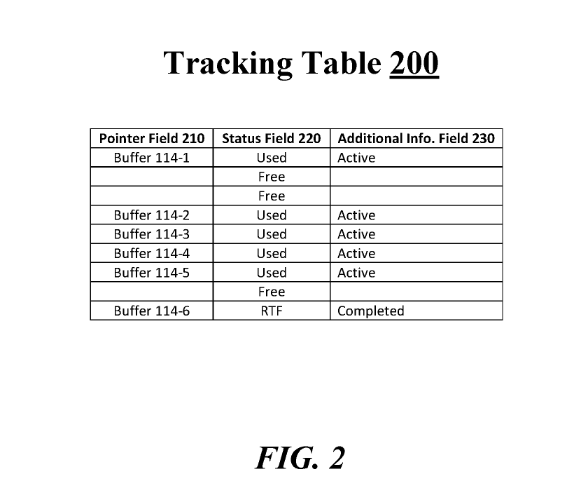

FIG. 2 illustrates an example tracking table 200. In some examples, tracking table 200 as shown in FIG. 2 may include information for a write command issued by a storage device controller to a single storage device coupled with a host computing platform such as a storage device from among storage devices 120-1 to 120-n coupled with host computing platform 110 as shown in FIG. 1. For these examples, the write command may be a WriteNoInterrupt command. The WriteNoInterrupt command may include information to direct the storage device to tracking table 200 that may be included in tracking table(s) 113 maintained in system memory device(s) 112 of system memory 109.

According to some examples, as shown in FIG. 2, tracking table 200 includes a pointer field 210, a status field 220 and an additional information field 230. Pointer field 210 may include pointers to buffers selected for temporarily storing data to be stored to the single storage device. Status field 220 may indicate a status of a given row of tracking table 200 as being either used, free or ready to be free (“RTF”). A “used” status may indicate that data copied or stored to a given buffer has yet to be completely written to or stored to the storage device. A “free” status may indicate that no buffer is being tracked in that given row of tracking table 200. An “RTF” status may indicate that the data copied or stored to the given buffer has been written to or stored to the storage device and the buffer may be freed for use by a storage device driver for a subsequent WriteNoInterrupt command. Additional information field 230 may include information that may relate to the actual writing or storing of the data to the storage device. For example, “active” may indicate that writing or storing of the data is currently in process. In other examples, “completed” may indicate the writing or storing is completed. In yet other examples, other information may include, but is not limited to, error information, indication that a storage device is gone or is malfunctioning or a time out indication if the writing or storing of the data to the storage device exceeded a time threshold.

For tracking table 200 shown in FIG. 2, the six buffers marked as “used” or “RTF” may be included in buffer 114 maintained in system memory device(s) 112 of system memory 109. Thus, as shown in FIG. 2, buffers 114-1 to 114-5 are shown as being “used” and buffer 114-6 is shown as “RTF”. In some examples, a controller for the storage device implementing the WriteNoInterrupt command may cause status field 220 to be changed from “used” to “RTF” following writing or storing of data temporarily stored to the buffer. For example, the controller may change status field 220 to “RTF” for buffer 114-6 once writing or storing of data temporarily stored to buffer 114-6 is stored to storage memory devices of the storage device.

According to some examples, the storage device controller may implement flush or poll commands for tracking table 200 to see if all or at least a portion of table rows are either free or RTF before sending a completion indication to a requestor of a write request. Flush or poll commands may result in a polling operation of tracking table 200 at a configurable frequency. Following a polling operation, the storage device controller may be aware of what buffers and/or table rows are available to facilitate a WriteNoInterrupt command for a write request. This polling may enable a storage device driver to know if the data has been stored and may prevent the storage device driver from overcommitting buffer resources and/or overwriting information included in tracking table 200 when indicating write completion to the requestor.

In some examples, tracking table 200 shown in FIG. 2 has information related to buffers included in buffers 114 that is maintained in system memory device(s) 112 of system memory 109. For these examples, an application requesting the write request to the single storage device may be an application that permits volatile caching. In other examples, if the application requesting the write request did not permit volatile caching, tracking table 200 may instead include information related to buffers 134 that is maintained in memory device(s) 132 of persistent memory device 130. These other examples, demonstrate that a tracking table for a single storage device is not limited to use of buffers maintained in system memory devices of a system memory.

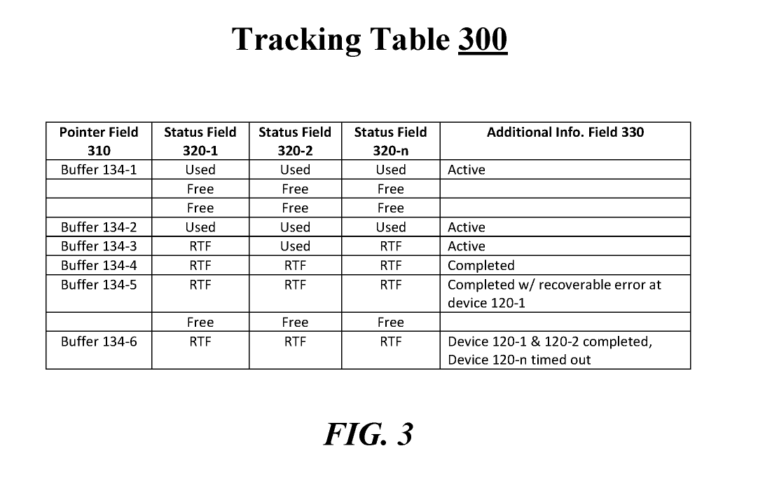

FIG. 3 illustrates an example tracking table 300. In some examples, tracking table 300 as shown in FIG. 3 may include information for a write command issued by a storage device controller to multiple storage devices coupled with a host computing platform such as storage devices 120-1 to 120-n coupled with host computing platform 110 as shown in FIG. 1. For these examples, the write command may be a WriteNoInterrupt command. The WriteNoInterrupt command may include information to enable each of the storage devices to locate tracking table 300 that may be included in tracking table(s) 113 maintained in system memory device(s) 112 of system memory 109.

According to some examples, as shown in FIG. 3, tracking table 300 includes a pointer field 310, status fields 320-1 to 320-n and an additional information field 330. These three types of fields are similar to the three types of fields described above for tracking table 200 shown in FIG. 2. The exception between fields of tracking table 200 and fields tracking table 300 is the addition of additional status fields. For these examples, status fields 320-1 to 320-n may correspond to respective storage devices 320-1 to 320-n.

For tracking table 300 shown in FIG. 3, the six buffers marked as “used” or “RTF” may be included in buffer 134 maintained in memory device(s) 132 of persistent memory device 130. In some examples the multiple storage devices corresponding to the multiple status fields may be arranged to support RAID operations. For these examples, storage devices 120-1 to 120-n may complete their respective write operations at differing times. For example, the status for buffer 134-3 indicates in status field 320-2 that storage device 120-2 is still using buffer 114-3 to complete its write operation since additional information field 330 indicates “Active”. In some examples, a controller for storage device 120-2 may cause status field 320-2 to be changed from “used” to “RTF” once writing or storing of data temporarily stored to buffer 134-3 is stored to storage memory device(s) 122. Additional information field 330 for buffer 134-3 may also be changed to no longer indicate “Active”.

According to some examples, controllers for storage devices may indicate in their respective status fields “RTF”. However, additional information field 330 may indicate potential issues with completion of write operations. For example, buffer 134-5 indicates “RTF” in all three status fields but additional information field 330 indicates that storage device 120-1 completed its write operation with recoverable errors. Also, buffer 134-6 indicates “RTF” in all three status fields but additional information field 330 indicates that storage device 120-n had timed out. In this timed out example, controller 124-n may have encountered issues (e.g., a defective storage memory device) that caused a write operation to exceed a time threshold. This time out issue may cause controller 124-n to update tracking table 300 to indicate RTF in status field 320-n and add the time out information in additional information field 330.

In some examples, tracking table 300 shown in FIG. 3 has information related to buffers included in buffers 134 that is maintained in memory device(s) 132 of persistent memory device 130. For these examples, an application requesting the write request to the single storage device may be an application that does not permit volatile caching and persistent memory buffers are available. In other examples, if the application requesting the write request does permit volatile caching, tracking table 300 may instead include information related to buffers 114 that is maintained in system memory device(s) 112 of system memory 109. These other examples, demonstrate that a tracking table for multiple storage devices is not limited to use of buffers maintained in memory devices of a persistent memory device.

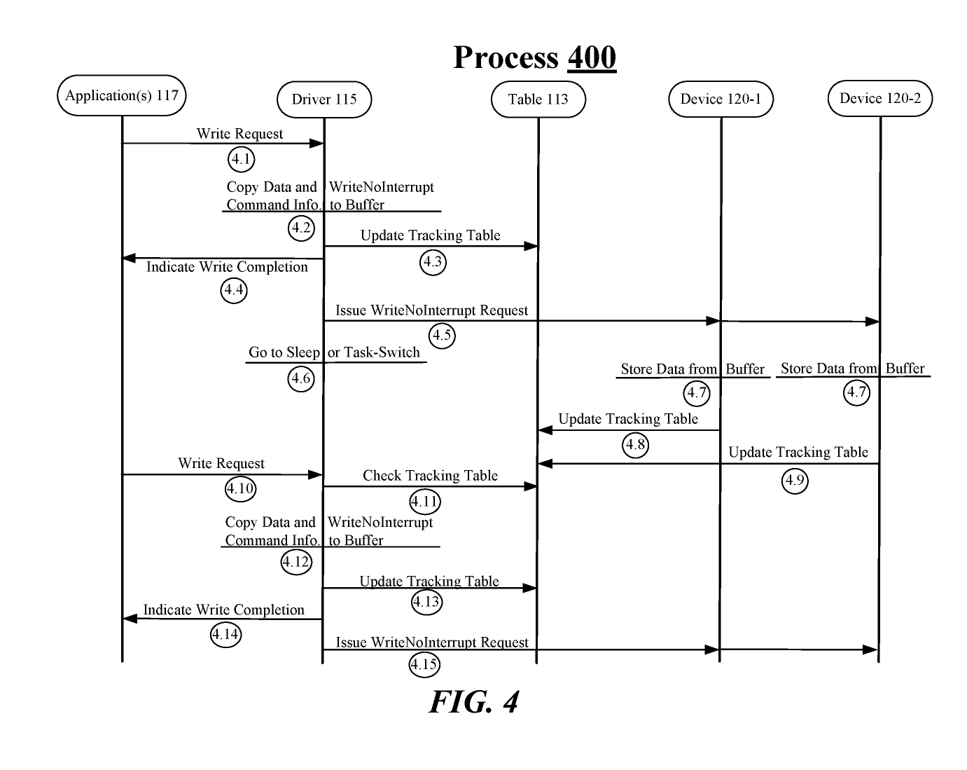

FIG. 4 illustrates an example process 400. In some examples, process 400 as shown in FIG. 4 depicts a process to allow for a write with no interrupt (WriteNoInterrupt) command to be completed and tracked. For these examples, process 400 may be implemented by or use components or elements of system 100 shown in FIG. 1 such as host computing platform 110, application(s) 117, storage device driver 115, persistent memory device driver, system memory 109, storage devices 120-1 to 120-n or persistent memory device 130. However, process 400 is not limited to being implemented by or use only these components or elements of system 100.

Beginning at process 4.1 (Write Request), an application from among application(s) 117 may send a write request to storage device driver 115. In some examples, the write request may be to write data to storage devices 120-1 and 120-2 coupled with host computing platform 110. According to some examples, the write request may involve the use of RAID levels that requires data associated with the write request to be stored to at least two different storage devices.

Moving to process 4.2 (Copy Data and WriteNoInterrupt Command Info. to Buffer), logic and/or features of storage device driver 115 may cause data associated with the write request and WriteNoInterrupt command information to be at least temporarily stored in one or more buffers maintained in either buffers 114 or buffers 134. In some examples, the WriteNoInterrupt command information may include write command information for completing write operations to store the data to storage devices 120-1 and 120-2. The WriteNoInterrupt command information may also indicate a tracking table location to locate a tracking table included in tracking table(s) 113.

Moving to process 4.3 (Update Tracking Table), logic and/or feature of storage device driver 115 may update the tracking table associated with the WriteNoInterrupt command to store the data copied to buffers 114 or 134. The update may include pointers to one or more buffers of buffers 114 that contain WriteNoInterrupt command information and the copied data to be stored to storage devices 120-1 and 120-2. The update may also indicate in the status fields for the storage devices that these pointer to the one or more buffers have a status of “used”.

Moving to process 4.4 (Indicate Write Completion), logic and/or features of storage device driver 115 may indicate completion of the write request to the requestor application from among application(s) 117. In some examples, although the data has not been completely stored to storage devices 120-1 to 120-2 (only copied to buffers 114 or 134), from the perspective the requestor application, the data has been stored to these storage devices.

Moving to process 4.5 (Issue WriteNoInterrupt Request), logic and/or features of storage device driver 115 may issue or send a WriteNoInterrupt request to storage devices 120-1 and 120-2. In some examples, the WriteNoInterrupt request may as be referred to as a storage write request having a no interrupt response and may include an indication of a buffer location in buffers 114 or 134 for WriteNoInterrupt command information and associated data to be stored to storage devices 120-1 to 120-2. For these examples, the WriteNoInterrupt request may be accepted by respective controllers 122-1 and 122-2 of storage devices 120-1 and 120-2 via a write mechanism such as a doorbell mechanism. This write mechanism may involve using communication protocols compliant with the NVMe specification.

Moving to process 4.6 (Go to Sleep or Task-Switch), logic and/or features of storage device driver 115 may then enter a low power state such as a sleep state or may task-switch to service or respond to additional write requests from other applications among application(s) 117.

Moving to process 4.7 (Store Data from Buffer), logic and/or features of controllers 124-1 and 124-2 at respective storage devices 120-1 and 120-2 may accept the WriteNoInterrupt request and store data included in one or more buffers of buffers 114 or 134 to their respective storage memory device(s) 124-1 and 124-2.

Moving to process 4.8 (Update Tracking Table), logic and/or features of controller 124-1 at storage device 120-1 may update the tracking table included in tracking table(s) 113 following the storing of data to storage memory device(s) 124-1. In some examples, logic and/or features of controller 124-1 uses WriteNoInterrupt command information associated with the data copied to the one or buffers of buffers 114 or 134 to locate the tracking table included in tracking table(s) 113. The update may include changing the status field for storage device 120-1 from “used” to “RTF” once data is pulled from the one or more buffers and stored to storage memory device(s) 124-1. The logic and/or features of controller 124-1 may also add additional information such as “completed” or “completed with recoverable errors” or may indicate that a time out was reached for writing data to one or more storage memory device(s) 124-1.

Moving to process 4.9 (Update Tracking Table), logic and/or features of controller 124-2 at storage device 120-2 may update the tracking table included in tracking table(s) 113 following the storing of data to storage memory device(s) 124-2. In some examples, logic and/or features of controller 124-2 uses WriteNoInterrupt command information associated with the data copied to the one or buffers of buffers 114 or 134 to locate the tracking table included in tracking table(s) 113. The update may include changing the status field for storage device 120-2 from “used” to “RTF” once data is pulled from the one or more buffers and stored to storage memory device(s) 124-2. The logic and/or features of controller 124-2 may also add additional information such as “completed” or “completed with recoverable errors” or may indicate that a time out was reached for writing data to one or more storage memory device(s) 124-2.

Moving to process 4.10 (Write Request), the application from among applicant(s) 117 may send a second write request to storage device driver 115. In some examples, the second write request may be to again write data to storage devices 120-1 and 120-2 coupled with host computing platform 110.

Moving to process 4.11 (Check Tracking Table), logic and/or features of storage device driver 115 may check the tracking table included in tracking table(s) 113 to determine if enough buffers included in buffers 114 or 134 are available for completing the second writing request. In some examples, this determination may be based on a sufficient number of rows of the tracking table having a status of “free” or “RTF” in order to copy an amount of data associated with the second write request. For these examples, the logic and/or features of storage device driver 115 may either wait a period of time before denying the second write request to allow storage devices to change the status for enough buffers and/or table entries to accept the second write request or may just deny the second write request.

Moving to process 4.12 (Copy Data and WriteNoInterrupt Command Info. to Buffer), logic and/or features of storage device driver 115 may cause data associated with an accepted second write request and WriteNoInterrupt command information to one or more buffers maintained in either buffers 114 or buffers 134. In some examples, the WriteNoInterrupt command information may include write command information for completing write operations to store the data to storage devices 120-1 and 120-2. As mentioned previously, the WriteNoInterrupt command information may also indicate a tracking table location to locate the tracking table included in tracking table(s) 113.

Moving to process 4.13 (Update Tracking Table), logic and/or features of storage device driver 115 may update the tracking table associated with the WriteNoInterrupt command to store the data copied to buffers 114 or 134. The update may include pointers to one or more buffers of buffers 114 that contain WriteNoInterrupt command information and the copied data to be stored to storage devices 120-1 and 120-2. The update may also indicate in the status fields for storage devices that these pointed to buffers have a status of “used”.

Moving to process 4.14 (Indicate Write Completion), logic and/or features of storage device driver 115 may indicate completion of the second write request to the requestor application from among application(s) 117. In some examples, although the data has not been completely stored to storage devices 120-1 to 120-2 (only copied to buffers 114 or 134), from the perspective the requestor application, the data has been stored to these storage devices.

Moving to process 4.15 (Issue WriteNoInterrupt Request), logic and/or features of storage device driver 115 may issue or send a second WriteNoInterrupt request to storage devices 120-1 and 120-2. In some examples, the second WriteNoInterrupt request may include an indication of a buffer location in buffers 114 or 134 for WriteNoInterrupt command information and associated data to be stored to storage devices 120-1 to 120-2. For these examples, the second WriteNoInterrupt request may be accepted by respective controllers 122-1 and 122-2 of storage devices 120-1 and 120-2 via a write mechanism such as a doorbell mechanism. This write mechanism may involve using communication protocols compliant with the NVMe specification. The process may then move to process 4.6.

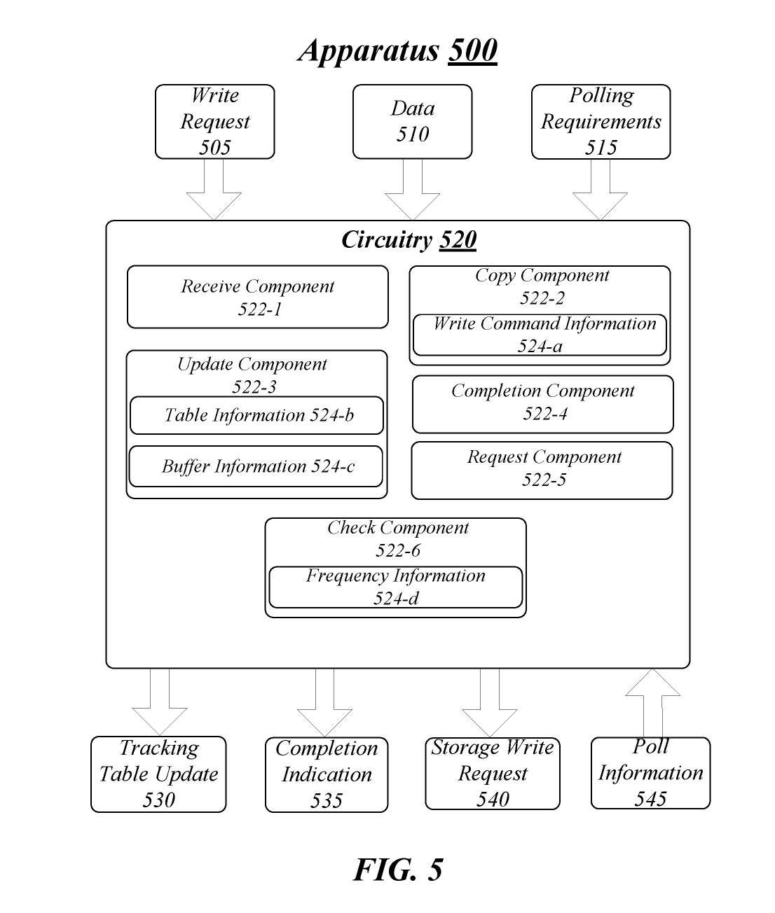

FIG. 5 illustrates an example block diagram for an apparatus 500. Although apparatus 500 shown in FIG. 5 has a limited number of elements in a certain topology, it may be appreciated that the apparatus 500 may include more or less elements in alternate topologies as desired for a given implementation.

The apparatus 500 may be supported by circuitry 520 and apparatus 500 may be a storage device driver for a host computing platform such as storage device driver 115 of system 100 shown in FIG. 1. Circuitry 520 may be arranged to execute one or more software or firmware implemented components or modules 522-a (e.g., implemented, at least in part, by a storage controller of a storage device). It is worthy to note that “a” and “b” and “c” and similar designators as used herein are intended to be variables representing any positive integer. Thus, for example, if an implementation sets a value for a=6, then a complete set of software or firmware for components or modules 522-a may include components 522-1, 522-2, 522-3, 522-4, 522-5 or 522-6. Also, these “components” may be software/firmware stored in computer-readable media, and although the components are shown in FIG. 5 as discrete boxes, this does not limit these components to storage in distinct computer-readable media components (e.g., a separate memory, etc.).

According to some examples, circuitry 520 may include a processor or processor circuitry. The processor or processor circuitry can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 520 may also include one or more application-specific integrated circuits (ASICs) and at least some components 522-a may be implemented as hardware elements of these ASICs. According to some examples, circuitry 520 may also include a field programmable gate array (FPGA) and at least some logic 522-a may be implemented as hardware elements of the FPGA.

According to some examples, apparatus 500 may include a receive component 522-1. Receive component 522-1 may be executed by circuitry 520 to receive a write request to store data to one or more storage devices coupled with a host computing platform that may include apparatus 500. For these examples, the request may be included in write request 505 and may be received from an application hosted by the host computing platform. The application may or may not permit volatile caching of data included in data 510 prior to storage of the data to the one or more storage devices.

In some examples, apparatus 500 may also include a copy component 522-2. Copy component 522-2 may be executed by circuitry 520 to cause the data to be copied to one or more buffers maintained in system memory of the host computing platform or maintained at a persistent memory device coupled with the host computing platform. Also included with the data to be copied to the one or more buffers may be information for a write command. The information for the write command may include a location of a tracking table maintained in the system memory. For these examples, the information for the write command may be at least temporarily maintained by copy component 522-2 with write command information 524-a (e.g., in a lookup table LUT).

In some examples, copy component 522-2 may cause data included in data 510 to be copied to buffers maintained in system memory of the host computing platform if volatile caching is permitted. In other examples, copy component 522-2 may cause data included in data 510 to be copied to buffers maintained at the persistent memory device if volatile caching is not permitted.

According to some examples, apparatus 500 may also include an update component 522-3. Update component 522-3 may be executed by circuitry 520 to update the tracking table to include pointers to the one or more buffers and indicate a separate status of the one or more buffers related to use of the one or more buffers for storing the data to the one or more storage devices. For these examples, updates to the tracking table may be included in tracking table update 530. Update component 522-3 may maintain table information 524-b (e.g., in a LUT) that may indicate a status of the one or more buffers as being used in association with a write request and where that status information is located in the tracking table maintained in the system memory of the host computing platform that includes apparatus 500. Update component 522-3 may also maintain buffer information 524-c (e.g., in a LUT) that indicates what buffers were used in either system memory or at the persistent memory device for the copying of the data.

In some examples, apparatus 500 may also include a completion component 522-4. Completion component 522-4 may be executed by circuitry 520 to send an indication of completion of the write request to a requestor of the write request. In some examples, the indication of completion may be included in completion indication 535. Completion indication 535, for example, may be sent to an application hosted by the host computing platform that includes apparatus 500.

According to some examples, apparatus 500 may also include a request component 522-5. Request component 522-5 may be executed by circuitry 520 to send a storage write request to one or more storage devices, the storage write request having a no interrupt response to the host computing platform by the one or more storage devices. The storage write request may be included in storage write request 540 and may include an indication of a buffer location among the one or more buffers for accessing the information for the write command. The one or more storage devices may use the information for the write command to locate the tracking table in the system memory and update the tracking table by changing the separate status of the one or more buffers to indicate storing of the data to respective one or more storage devices has been completed.

In some examples, apparatus 500 may also include a check component 522-6. Check component 522-6 may be executed by circuitry 520 to poll the tracking table at a configurable frequency or upon receipt of a second write request to determine whether the separate status of the one or buffers have been changed from the respective used status to the respective ready to be free status to verify that the storing of the data to the respective one or more storage devices has been completed. For these examples, the configurable frequency may be based on received polling requirements 515 that may be used to determine the configurable frequency based on configuration frequency information 524-d maintained by check component 522-6 (e.g., in a LUT). The obtained information from the polling of the tracking table may be included in poll information 545.

According to some examples, polling requirements 515 may indicate timing requirements for which check component 522-6 needs to poll or check the tracking table to verify that the storing of the data to the one or more storage devices has been completed. The timing requirements may be related to a balance between attempting to maximize power saving or idling times versus verifying the data has been stored. For example, polling at an increased frequency may cause the host computing device to exit a power save or idle mode such that power saving efforts may be reduced. Also, a low frequency of polling may result in delays in recognizing and correcting a potential issue with the storing of the data to the one or more storage devices.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

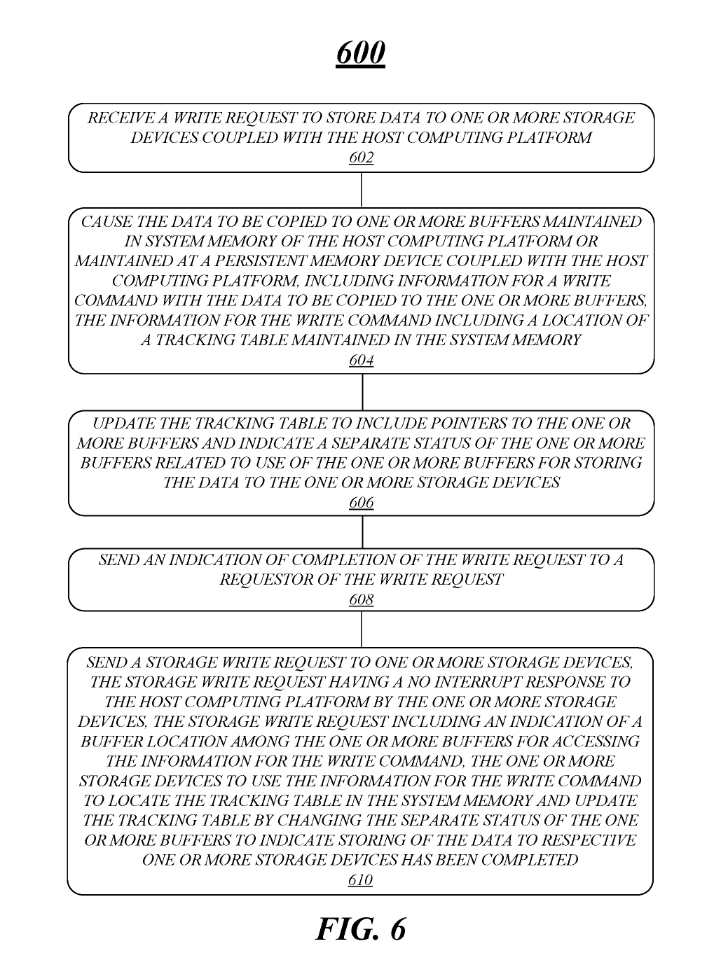

FIG. 6 illustrates an example of a logic flow 600. Logic flow 600 may be representative of some or all of the operations executed by one or more logic, features, or devices described herein, such as apparatus 600. More particularly, logic flow 600 may be implemented by one or more of receive component 522-1, copy component 522-2, update component 522-3, completion component 522-4 or request component 522-5.

According to some examples, logic flow 600 at block 602 may receive a write request to store data to one or more storage devices coupled with a host computing platform. For these example, apparatus 500 may be included in the host computing platform and receive component 522-1 of apparatus 500 may receive the write request.

In some examples, logic flow 600 at block 604 may cause the data to be copied to one or more buffers maintained in system memory of the host computing platform or maintained at a persistent memory device coupled with the host computing platform, including information for a write command with the data to be copied to the one or more buffers, the information for the write command including a location of a tracking table maintained in the system memory. For these examples copy component 522-2 may cause the data to be copied to the one or more buffers and may include the information for the write command with the data.

According to some examples, logic flow 600 at block 606 may update the tracking table to include pointers to the one or more buffers and indicate a separate status of the one or more buffers related to use of the one or more buffers for storing the data to the one or more storage devices. For these examples, update component 522-3 may update the tracking table.

In some examples, logic flow 600 at block 608 may send an indication of completion of the write request to a requestor of the write request. For these examples, request component may send the indication of completion of the write request to the requestor.

According to some examples, logic flow 600 at block 610 may send a storage write request to one or more storage devices, the storage write request to have a no interrupt response to the host computing platform by the one or more storage devices, the storage write request including an indication of a buffer location among the one or more buffers for accessing the information for the write command, the one or more storage devices to use the information for the write command to locate the tracking table in the system memory and update the tracking table by changing the separate status of the one or more buffers to indicate storing of the data to respective one or more storage devices has been completed. For these examples, request component 522-5 may send the storage write request.

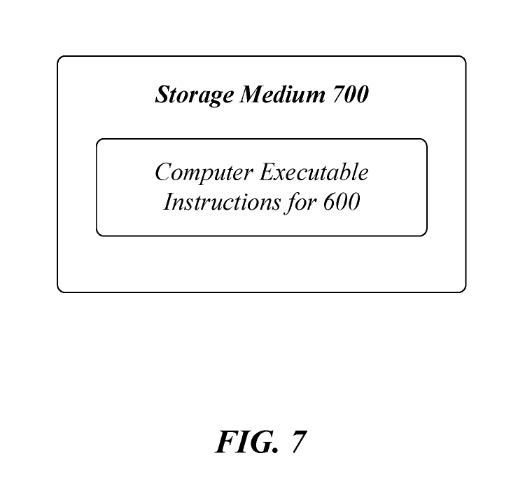

FIG. 7 illustrates an example of a first storage medium. As shown in FIG. 7, the first storage medium includes a storage medium 700. The storage medium 700 may comprise an article of manufacture. In some examples, storage medium 700 may include any non-transitory computer readable medium or machine readable medium, such as an optical, magnetic or semiconductor storage. Storage medium 700 may store various types of computer executable instructions, such as instructions to implement logic flow 700. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

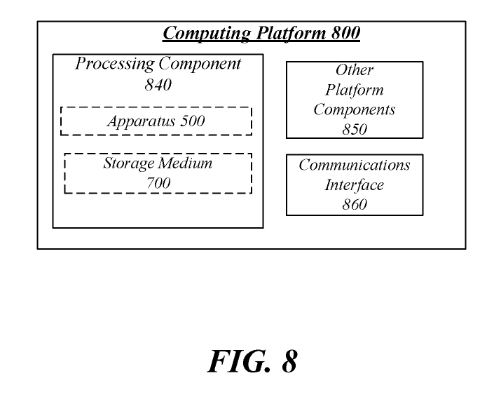

FIG. 8 illustrates an example computing platform 800. In some examples, as shown in FIG. 8, computing platform 800 may include a processing component 840, other platform components 850 or a communications interface 860. According to some examples, computing platform 800 may be a host computing platform similar to host computing platform 110 shown in FIG. 1 and described above.

According to some examples, processing component 840 may execute processing operations or logic for apparatus 500 and/or storage medium 700. Processing component 840 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 850 may include common computing elements, such as one or more processors, multi-core processors, co-processors, memory units, chipsets, controllers, peripherals, interfaces, oscillators, timing devices, video cards, audio cards, multimedia I/O components (e.g., digital displays), power supplies, and so forth. Examples of memory units associated with either other platform components 850 or storage system 830 may include without limitation, various types of computer readable and machine readable storage media in the form of one or more higher speed memory units, such as read-only memory (ROM), RAM, DRAM, DDR-RAM, SDRAM, SRAM, programmable ROM (PROM), erasable PROM (EPROM), EEPROM, flash memory, ferroelectric memory, SONOS memory, polymer memory such as ferroelectric polymer memory, nanowire, FeTRAM or FeRAM, ovonic memory, nanowire, EEPROM, phase change memory, memristers, STT-MRAM, magnetic or optical cards, persistent memory devices, solid state memory devices, SSDs, HDDs or any other type of storage media suitable for storing information.

In some examples, communications interface 860 may include logic and/or features to support a communication interface. For these examples, communications interface 860 may include one or more communication interfaces that operate according to various communication protocols or standards to communicate over direct or network communication links. Direct communications may occur through a direct interface via use of communication protocols or standards described in one or more industry standards (including progenies and variants) such as those associated with the SMBus specification, the PCIe specification, the NVMe specification, the SATA specification, SAS specification or the USB specification. Network communications may occur through a network interface via use of communication protocols or standards such as those described in one or more Ethernet standards promulgated by the IEEE. For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”).

Computing platform 800 may be part of a computing device that may be, for example, user equipment, a computer, a personal computer (PC), a desktop computer, a laptop computer, a notebook computer, a netbook computer, a tablet, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing platform 800 described herein, may be included or omitted in various embodiments of computing platform 800, as suitably desired.

The components and features of computing platform 800 may be implemented using any combination of discrete circuitry, ASICs, logic gates and/or single chip architectures. Further, the features of computing platform 800 may be implemented using microcontrollers, programmable logic arrays and/or microprocessors or any combination of the foregoing where suitably appropriate. It is noted that hardware, firmware and/or software elements may be collectively or individually referred to herein as “logic”, “circuit” or “circuitry.”

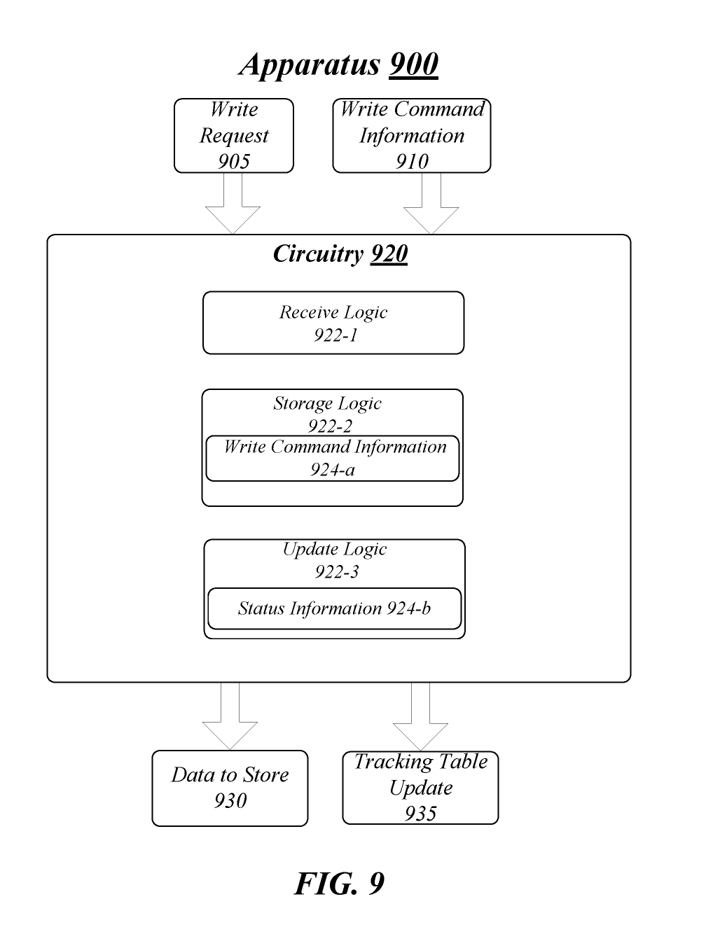

FIG. 9 illustrates an example block diagram for an apparatus 900. Although apparatus 900 shown in FIG. 9 has a limited number of elements in a certain topology, it may be appreciated that the apparatus 900 may include more or less elements in alternate topologies as desired for a given implementation.

The apparatus 900 may be supported by circuitry 920 and apparatus 900 may be a controller maintained at a storage device such as controller 124-1 for storage device 120-1 of system 100 shown in FIG. 1. The storage device may be coupled to a host computing platform or device similar to host computing platform 110 also shown in FIG. 1. Also, as mentioned above, the storage device may include one or more memory devices or dies to store data associated with a WriteNoInterrupt command. Circuitry 920 may be arranged to execute one or more software or firmware implemented logic, components or modules 922-a (e.g., implemented, at least in part, by a storage controller of a storage device). It is worthy to note that “a” and “b” and “c” and similar designators as used herein are intended to be variables representing any positive integer. Thus, for example, if an implementation sets a value for a=3, then a complete set of software or firmware for logic, components or modules 922-a may include logic 922-1, 922-2 or 922-3. Also, “logic”, “components” or “modules” may be software/firmware stored in computer-readable media, and although the components are shown in FIG. 9 as discrete boxes, this does not limit these components to storage in distinct computer-readable media components (e.g., a separate memory, etc.).

According to some examples, circuitry 920 may include a processor or processor circuitry. The processor or processor circuitry can be any of various commercially available processors to include, but not limited to, the processors mentioned above for apparatus 500. Also, according to some examples, circuitry 920 may also include one or more ASICs and at least some logic, modules or components 922-a may be implemented as hardware elements of these ASICs. According to some examples, circuitry 920 may also include an FPGA and at least some logic, modules or components 922-a may be implemented as hardware elements of the FPGA.

According to some examples, apparatus 900 may include a receive logic 922-1. Receive logic 922-1 may be executed by circuitry 920 to receive a write request having a no interrupt response to a storage device driver at a host computing platform coupled with the storage device. The write request may indicate a buffer location among one or more buffers that have information for a write command to store data to be copied from the one or more buffers. For these examples, the write request may be included in write request 905.

In some examples, apparatus 900 may also include a storage logic 922-2. Storage logic 922-2 may be a executed by circuitry 920 to cause the data to be stored to the storage device based, at least in part, on the information for the write command. For these examples, storage logic 922-2 may obtain write command information from write command information 910 based on the information for the write command included in the buffer location among the one or more buffers. Storage component logic 922-2 may maintain write command information 924-a (e.g., in a LUT) to facilitate the storing of the data included in data to store 930 to the storage device.

According to some examples, apparatus 900 may also include an update logic 922-3. Update logic 922-3 may be executed by circuitry 920 to update a tracking table maintained at system memory of the host computing platform. The tracking table may be located in the system memory based on the information for the write command. The update to include an indication of a separate status of the one or more buffers that provides an indication of whether the data has been copied to the storage device. For these examples, update component 922-3 may maintain status information 924-b (e.g., in a LUT) to include status information (e.g., active or completed) for the storing of the data included in data to store 930 and to include status information in the update to the tracking table. The update to the tracking table may be included in tracking table update 935 and may cause the status of the one or more buffers to change from “used” to “RFT”.

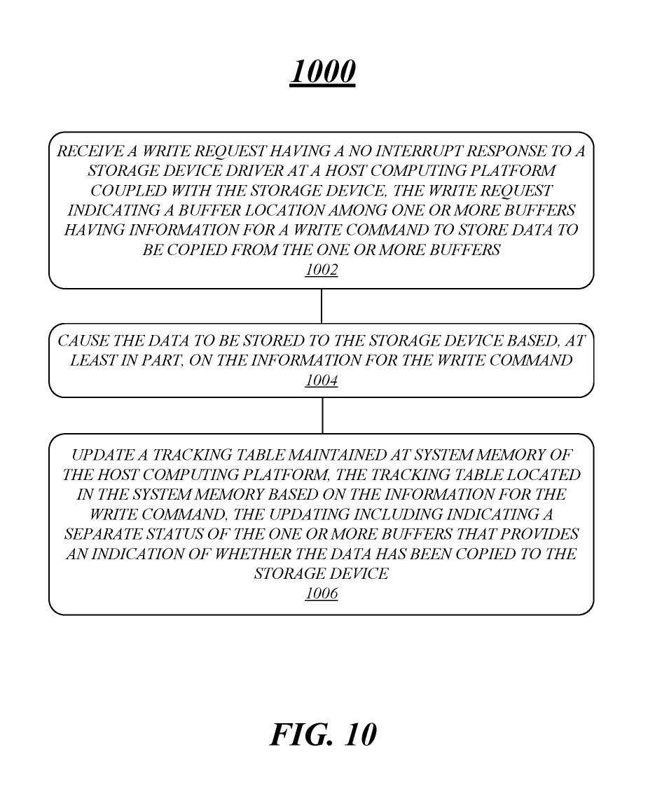

FIG. 10 illustrates an example of a logic flow 1000. Logic flow 1000 may be representative of some or all of the operations executed by one or more logic, features, or devices described herein, such as apparatus 1000. More particularly, logic flow 1000 may be implemented by one or more of receive logic 922-1, storage logic 922-2 or update logic 922-3.

According to some examples, logic flow 1000 at block 1002 may receive a write request having a no interrupt response to a storage device driver at a host computing platform coupled with the storage device, the write request to indicate a buffer location among one or more buffers having information for a write command to store data to be copied from the one or more buffers. For these examples, receive logic 922-1 may receive the write request.

In some examples, logic flow 1000 at block 1004 may cause the data to be stored to the storage device based, at least in part, on the information for the write command. For these examples, storage logic 922-2 may cause the data to be stored to the storage device.

According to some examples, logic flow 1000 at block 1006 may update a tracking table maintained at system memory of the host computing platform, the tracking table located in the system memory based on the information for the write command, the updating including indicating a separate status of the one or more buffers that provides an indication of whether the data has been copied to the storage device. For these examples, update logic 922-3 may update the tracking table.

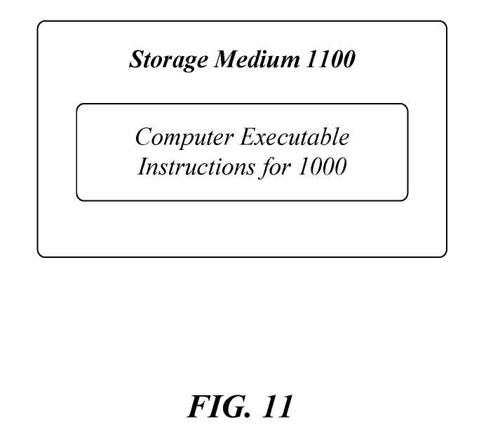

FIG. 11 illustrates an example of a first storage medium. As shown in FIG. 11, the first storage medium includes a storage medium 1100. The storage medium 1100 may comprise an article of manufacture. In some examples, storage medium 1100 may include any non-transitory computer readable medium or machine readable medium, such as an optical, magnetic or semiconductor storage. Storage medium 1100 may store various types of computer executable instructions, such as instructions to implement logic flow 1100. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

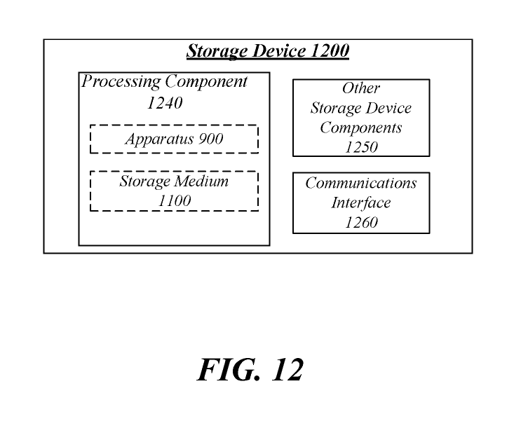

FIG. 12 illustrates an example storage device 1200. In some examples, as shown in FIG. 12, storage device 1200 may include a processing component 1240, other storage device components 1250 or a communications interface 1260. According to some examples, storage device 1200 may be capable of being coupled to a host computing device or platform. For example, host computing platform 110 shown in FIG. 1. Also, storage device 1200 may be similar to storage devices 120-1 to 120-n shown in FIG. 1 and described for FIGS. 1-4 in that storage device 1200 may be arranged to store data copied to one or more buffers either maintained at the host computing platform or maintained at a persistent memory device coupled with the host computing platform.

According to some examples, processing component 1240 may execute processing operations or logic for apparatus 900 and/or storage medium 1100. Processing component 1240 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASIC, programmable logic devices (PLD), digital signal processors (DSP), FPGA/programmable logic, memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software components, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other storage device components 1250 may include common computing elements or circuitry, such as one or more processors, multi-core processors, co-processors, memory units, chipsets, controllers, interfaces, oscillators, timing devices, power supplies, and so forth. Examples of memory units may include without limitation various types of computer readable and/or machine readable storage media in the form of one or more higher speed memory units, such as read-only memory (ROM), RAM, DRAM, DDR DRAM, synchronous DRAM (SDRAM), DDR SDRAM, SRAM, programmable ROM (PROM), EPROM, EEPROM, flash memory, ferroelectric memory, SONOS memory, polymer memory such as ferroelectric polymer memory, nanowire, FeTRAM or FeRAM, ovonic memory, phase change memory, memristers, STT-MRAM, magnetic or optical cards, and any other type of storage media suitable for storing information.

In some examples, communications interface 1260 may include logic and/or features to support a communication interface. For these examples, communications interface 1260 may include one or more communication interfaces that operate according to various communication protocols or standards to communicate over direct or network communication links. Direct communications may occur via use of communication protocols such as SMBus, PCIe, NVMe, QPI, SATA, SAS or USB communication protocols. Network communications may occur via use of communication protocols Ethernet, Infiniband, SATA or SAS communication protocols.

Storage device 1200 may be arranged as an SSD or an HDD that may be configured as described above for storage devices 120-1 to 120-n of system 100 as shown in FIG. 1. Accordingly, functions and/or specific configurations of storage device 1200 described herein, may be included or omitted in various embodiments of storage device 1200, as suitably desired.

The components and features of storage device 1200 may be implemented using any combination of discrete circuitry, ASICs, logic gates and/or single chip architectures. Further, the features of storage device 1200 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the example storage device 1200 shown in the block diagram of FIG. 12 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

### Example 1

An example apparatus may include circuitry at a storage device. The apparatus may also include a receive logic for execution by the circuitry to receive a write request having a no interrupt response to a storage device driver at a host computing platform coupled with the storage device. The write request may indicate a buffer location among one or more buffers that have information for a write command to store data to be copied from the one or more buffers. The apparatus may also include a storage logic for execution by the circuitry to cause the data to be stored to the storage device based, at least in part, on the information for the write command. The apparatus may also include an update logic for execution by the circuitry to update a tracking table maintained at system memory of the host computing platform. The tracking table may be located in the system memory based on the information for the write command. The update may include an indication of a separate status of the one or more buffers that provides an indication of whether the data has been copied to the storage device.

### Example 2

The apparatus of example 1, the update logic to update the tracking table may further include the update logic to include an indication of separate additional information of the one or more buffers that includes error information, time out information or storage device malfunctioning information.

### Example 3

The apparatus of example 1, the storage device may be arranged to access the one or more buffers and the tracking table through one or more input/output interfaces at the host computing platform. The one or more input/output interfaces may be arranged to operate in compliance with the NVMe Specification.

### Example 4

The apparatus of example 1, the one or more buffers may be maintained at the system memory of the host computing platform or maintained at a persistent memory device coupled with the host computing device.

### Example 5

The apparatus of example 4, the persistent memory device may include one or more memory devices capable of storing data structures such that the data structures continue to be accessible after the data structures are created and after power is restored to the one or more memory devices following a power loss to the one or more memory devices.

### Example 6

The apparatus of example 5, the one or more memory devices may be maintained on at least one DIMM coupled with the host computing platform.

### Example 7

The apparatus of example 5, the one or more memory devices may include volatile or non-volatile memory, the volatile memory including RAM, D-RAM, DDR SDRAM, SRAM, T-RAM or Z-RAM and the non-volatile memory including phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 8

The apparatus of example 1, the storage device may include one or more storage memory devices having chips or dies that may individually include one or more types of non-volatile memory including at least one of a phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 9

An example method may include receiving, at a controller for a storage device, a write request having a no interrupt response to a storage device driver at a host computing platform coupled with the storage device. The write request may indicate a buffer location among one or more buffers having information for a write command to store data to be copied from the one or more buffers. The method may also include causing the data to be stored to the storage device based, at least in part, on the information for the write command. The method may also include updating a tracking table maintained at system memory of the host computing platform. The tracking table may be located in the system memory based on the information for the write command. The updating may include indicating a separate status of the one or more buffers that provides an indication of whether the data has been copied to the storage device.

### Example 10

The method of example 9, updating the tracking table may further include the updating including indicating separate additional information of the one or more buffers including error information, time out information or storage device malfunctioning information.

### Example 11

The method of example 9, the storage device may be arranged to access the one or more buffers and the tracking table through one or more input/output interfaces at the host computing platform, the one or more input/output interfaces arranged to operate in compliance with the NVMe Specification.

### Example 12

The method of example 9, the one or more buffers may be maintained at the system memory of the host computing platform or may be maintained at a persistent memory device coupled with the host computing device.

### Example 13

The method of example 12, the persistent memory device may include one or more memory devices capable of storing data structures such that the data structures continue to be accessible after the data structures are created and after power is restored to the one or more memory devices following a power loss to the one or more memory devices.

### Example 14

The method of example 13, the one or more memory devices may be maintained on at least one DIMM coupled with the host computing platform.

### Example 15

The method of example 13, the one or more memory devices may include volatile or non-volatile memory, the volatile memory including RAM, D-RAM, DDR SDRAM, SRAM, T-RAM or Z-RAM and the non-volatile memory including phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 16

The method of example 13, the storage device may include one or more storage memory devices having chips or dies that may individually include one or more types of non-volatile memory including at least one of a phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 17

An example at least one machine readable medium may include a plurality of instructions that in response to being executed by a system may cause the system to carry out a method according to any one of examples 9 to 16.

### Example 18

An example apparatus may include means for performing the methods of any one of examples 9 to 16.

### Example 19

An example at least one machine readable medium may include a plurality of instructions that in response to being executed by a system at a storage device may cause the system to receive a write request having a no interrupt response to a storage device driver at a host computing platform coupled with the storage device. The write request may indicate a buffer location among one or more buffers that have information for a write command to store data to be copied from the one or more buffers. The instructions may also cause the system to cause the data to be stored to the storage device based, at least in part, on the information for the write command. The instructions may also cause the system to update a tracking table maintained at system memory of the host computing platform. The tracking table may be located in the system memory based on the information for the write command. The update may include an indication of a separate status of the one or more buffers that provides an indication of whether the data has been copied to the storage device.

### Example 20

The at least one machine readable medium of example 19, the instructions to cause the system to update the tracking table may further cause the system to include an indication of separate additional information of the one or more buffers that includes error information, time out information or storage device malfunctioning information.

### Example 21

The at least one machine readable medium of example 19, the storage device arranged to access the one or more buffers and the tracking table through one or more input/output interfaces at the host computing platform. The one or more input/output interfaces may be arranged to operate in compliance with the NVMe Specification.

### Example 22

The at least one machine readable medium of example 19, the one or more buffers may be maintained at the system memory of the host computing platform or maintained at a persistent memory device coupled with the host computing device.

### Example 23

The at least one machine readable medium of example 22, the persistent memory device may include one or more memory devices capable of storing data structures such that the data structures continue to be accessible after the data structures are created and after power is restored to the one or more memory devices following a power loss to the one or more memory devices.

### Example 24

The at least one machine readable medium of example 23, the one or more memory devices may be maintained on at least one DIMM coupled with the host computing platform.

### Example 25

The at least one machine readable medium of example 23, the one or more memory devices may include volatile or non-volatile memory, the volatile memory including RAM, D-RAM, DDR SDRAM, SRAM, T-RAM or Z-RAM and the non-volatile memory including phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 26

The at least one machine readable medium of example 19, the storage device may include one or more storage memory devices having chips or dies that may individually include one or more types of non-volatile memory including at least one of a phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 27

An example apparatus may include circuitry at a host computing platform. The apparatus may also include a receive component for execution by the circuitry to receive a write request to store data to one or more storage devices coupled with the host computing platform. The apparatus may also include a copy component for execution by the circuitry to cause the data to be copied to one or more buffers maintained in system memory of the host computing platform or maintained at a persistent memory device coupled with the host computing platform. The copy component may include information for a write command with the data to be copied to the one or more buffers. The information for the write command may include a location of a tracking table maintained in the system memory. The apparatus may also include an update component for execution by the circuitry to update the tracking table to include pointers to the one or more buffers and indicate a separate status of the one or more buffers related to use of the one or more buffers for storing the data to the one or more storage devices. The apparatus may also include a completion component for execution by the circuitry to send an indication of completion of the write request to a requestor of the write request. The apparatus may also include a request component for execution by the circuitry to send a storage write request to one or more storage devices. The storage write request may have a no interrupt response to the host computing platform by the one or more storage devices. The storage write request may include an indication of a buffer location among the one or more buffers for accessing the information for the write command. The one or more storage devices may use the information for the write command to locate the tracking table in the system memory and update the tracking table to change the separate status of the one or more buffers to indicate storage of the data to respective one or more storage devices has been completed.

### Example 28

The apparatus of example 27, the update component may update the tracking table to indicate the separate status of the one or more buffers includes the separate status to indicate that the one or more buffers are being used to store the data to the one or more storage devices.

### Example 29

The apparatus of example 28, the one or more storage devices to change the separate status of the one or more buffers includes the one or more storage devices to change the separate status of the one or more buffers from a respective used status to a respective ready to be free status to indicate storage of the data to respective one or more storage devices has been completed.

### Example 30

The apparatus of example 29 may also include a check component for execution by the circuitry to poll the tracking table at a configurable frequency or upon receipt of a second write request to determine whether the separate status of the one or buffers have been changed from the respective used status to the respective ready to be free status to verify that the storing of the data to the respective one or more storage devices has been completed.

### Example 31

The apparatus of example 27 may also include the write request to store data to the one or more storage devices may be received from an application hosted by the host computing platform. The application may be arranged to permit volatile caching of the data prior to storage to the one or more storage devices. The apparatus may also include the copy component to cause the data to be copied to one or more buffers maintained in the system memory of the host computing platform.

### Example 32

The apparatus of example 27, the write request to store data to the one or more storage devices may be received from an application hosted by the host computing platform. The application may be arranged to not permit volatile caching of the data prior to storage to the one or more storage devices. The apparatus may also include the copy component to cause the data to be copied to one or more buffers maintained in the persistent memory device coupled with the host computing platform.

### Example 33

The apparatus of example 27, the one or more storage devices may be arranged to access the one or more buffers and the tracking table through one or more input/output interfaces at the host computing platform. The one or more input/output interfaces may be arranged to operate in compliance with the NVMe Specification.

### Example 34

The apparatus of example 27, the persistent memory device may include one or more memory devices capable of storing data structures such that the data structures continue to be accessible after the data structures are created and after power is restored to the one or more memory devices following a power loss to the one or more memory devices.

### Example 35

The apparatus of example 34, the one or more memory devices may be maintained on at least one DIMM coupled with the host computing platform.

### Example 36

The apparatus of example 34, the one or more memory devices may include volatile or non-volatile memory, the volatile memory including RAM, D-RAM, DDR SDRAM, SRAM, T-RAM or Z-RAM and the non-volatile memory including phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 37

The apparatus of example 27, the one or more storage devices may separately include one or more storage memory devices that have chips or dies that may individually include one or more types of non-volatile memory including at least one of a phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 38

The apparatus of example 27 may also include one or more of a network interface communicatively coupled to the apparatus, a battery coupled to the apparatus or a display communicatively coupled to the apparatus.

### Example 39

An example method may include receiving, at a processor circuit for a host computing platform, a write request to store data to one or more storage devices coupled with the host computing platform. The method may also include causing the data to be copied to one or more buffers maintained in system memory of the host computing platform or maintained at a persistent memory device coupled with the host computing platform. For these examples information for a write command may be included with the data to be copied to the one or more buffers. The information for the write command may include a location of a tracking table maintained in the system memory. The method may also include updating the tracking table to include pointers to the one or more buffers and indicate a separate status of the one or more buffers related to use of the one or more buffers for storing the data to the one or more storage devices. The method may also include sending an indication of completion of the write request to a requestor of the write request. The method may also include sending a storage write request to one or more storage devices. The storage write request may have a no interrupt response to the host computing platform by the one or more storage devices. The storage write request may include an indication of a buffer location among the one or more buffers for accessing the information for the write command. The one or more storage devices may use the information for the write command to locate the tracking table in the system memory and update the tracking table by changing the separate status of the one or more buffers to indicate storing of the data to respective one or more storage devices has been completed.

### Example 40

The method of example 39, updating the tracking table to indicate the separate status of the one or more buffers may include the separate status indicating the one or more buffers are being used to store the data to the one or more storage devices.

### Example 41

The method of example 40, changing the separate status of the one or more buffers may include the one or more storage devices to change the separate status of the one or more buffers from a respective used status to a respective ready to be free status to indicate storing of the data to respective one or more storage devices has been completed.

### Example 42

The method of example 41 may also include polling the tracking table at a configurable frequency or upon receiving a second write request to determine whether the separate status of the one or buffers have been changed from the respective used status to the respective ready to be free status to verify that the storing of the data to the respective one or more storage devices has been completed.

### Example 43

The method of example 39, the write request to store data to the one or more storage devices may be sent from an application hosted by the host computing platform. The application may be arranged to permit volatile caching of the data prior to storage to the one or more storage devices. The method may also include causing the data to be copied to one or more buffers maintained in the system memory of the host computing platform.

### Example 44

The method of example 39 may also include the write request to store data to the one or more storage devices being sent from an application hosted by the host computing platform. The application may be arranged to not permit volatile caching of the data prior to storage to the one or more storage devices. The method may also include causing the data to be copied to one or more buffers maintained in the persistent memory device coupled with the host computing platform.

### Example 45

The method of example 39, the one or more storage devices may be arranged to access the one or more buffers and the tracking table through one or more input/output interfaces at the host computing platform. The one or more input/output interfaces may be arranged to operate in compliance with the NVMe Specification.

### Example 46

The method of example 39, the persistent memory device may include one or more memory devices capable of storing data structures such that the data structures continue to be accessible after the data structures are created and after power is restored to the one or more memory devices following a power loss to the one or more memory devices.

### Example 47

The method of example 46, the one or more memory devices may be maintained on at least one DIMM coupled with the host computing platform.

### Example 48

The method of example 46, the one or more memory devices may include volatile or non-volatile memory, the volatile memory including RAM, D-RAM, DDR SDRAM, SRAM, T-RAM or Z-RAM and the non-volatile memory including phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 49

The method of example 39, comprising the one or more storage devices separately including one or more storage memory devices having chips or dies that may individually include one or more types of non-volatile memory including at least one of a phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 50

An example at least one machine readable medium may include a plurality of instructions that in response to being executed by a system may cause the system to carry out a method according to any one of examples 39 to 49.

### Example 51

An example apparatus may include means for performing the methods of any one of examples 39 to 49.

### Example 52

At least one machine readable medium may include a plurality of instructions that in response to being executed by a system at a host computing platform may cause the system to receive a write request to store data to one or more storage devices coupled with the host computing platform. The instructions may also cause the system to cause the data to be copied to one or more buffers maintained in system memory of the host computing platform or maintained at a persistent memory device coupled with the host computing platform. For these examples, information for a write command may be included with the data to be copied to the one or more buffers. The information for the write command may include a location of a tracking table maintained in the system memory. The instructions may also cause the system to update the tracking table to include pointers to the one or more buffers and indicate a separate status of the one or more buffers related to use of the one or more buffers for storing the data to the one or more storage devices. The instructions may also cause the system to send an indication of completion of the write request to a requestor of the write request. The instructions may also cause the system to send a storage write request to one or more storage devices, the storage write request having a no interrupt response to the host computing platform by the one or more storage devices. The storage write request may include an indication of a buffer location among the one or more buffers to access the information for the write command. The one or more storage devices may use the information for the write command to locate the tracking table in the system memory and update the tracking table by changing the separate status of the one or more buffers to indicate storing of the data to respective one or more storage devices has been completed.

### Example 53

The at least one machine readable medium of example 52, the instructions to cause the system to update the tracking table may further cause the system to indicate the one or more buffers are being used to store the data to the one or more storage devices.

### Example 54

The least one machine readable medium of example 53, the one or more storage devices to change the separate status of the one or more buffers may include the one or more storage devices to change the separate status of the one or more buffers from a respective used status to a respective ready to be free status to indicate storing of the data to respective one or more storage devices has been completed.

### Example 55

The at least one machine readable medium of example 54, the instructions may further cause the system to poll the tracking table at a configurable frequency or upon receiving a second write request to determine whether the separate status of the one or buffers have been changed from the respective used status to the respective ready to be free status to verify that the storing of the data to the respective one or more storage devices has been completed.

### Example 56

The at least one machine readable medium of example 52, the write request to store data to the one or more storage devices may be sent from an application hosted by the host computing platform. The application may be arranged to permit volatile caching of the data prior to storage to the one or more storage devices. The instructions may further cause the system to cause the data to be copied to one or more buffers maintained in the system memory of the host computing platform.

### Example 57

The at least one machine readable medium of example 52, the write request to store data to the one or more storage devices may be sent from an application hosted by the host computing platform. The application may be arranged to not permit volatile caching of the data prior to storage to the one or more storage devices. The instructions may further cause the system to cause the data to be copied to one or more buffers maintained in the persistent memory device coupled with the host computing platform.

### Example 58

The at least one machine readable medium of example 52, the one or more storage devices may be arranged to access the one or more buffers and the tracking table through one or more input/output interfaces at the host computing platform. The one or more input/output interfaces may be arranged to operate in compliance with the NVMe Specification.

### Example 59

The at least one machine readable medium of example 52, the persistent memory device may include one or more memory devices capable of storing data structures such that the data structures continue to be accessible after the data structures are created and after power is restored to the one or more memory devices following a power loss to the one or more memory devices.

### Example 60

The at least one machine readable medium of example 59, the one or more memory devices may be maintained on at least one DIMM coupled with the host computing platform.

### Example 61

The at least one machine readable medium of example 59, the one or more memory devices may include volatile or non-volatile memory, the volatile memory including RAM, D-RAM, DDR SDRAM, SRAM, T-RAM or Z-RAM and the non-volatile memory including phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 62

The least one machine readable medium of example 52, the one or more storage devices may separately include one or more storage memory devices having chips or dies that may individually include one or more types of non-volatile memory including at least one of a phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
circuitry at a storage device;
a receive logic for execution by the circuitry to receive a write request having a no interrupt response to a storage device driver at a host computing platform coupled with the storage device, the write request to indicate a buffer location among one or more buffers that have information for a write command to store data to be copied from the one or more buffers;
a storage logic for execution by the circuitry to cause the data to be stored to the storage device based, at least in part, on the information for the write command; and
an update logic for execution by the circuitry to update a tracking table maintained at system memory of the host computing platform, the tracking table located in the system memory based on the information for the write command, the update to include an indication of a separate status of the one or more buffers that provides an indication of whether the data has been copied to the storage device.

2. The apparatus of claim 1, the update logic to update the tracking table further comprises the update logic to include an indication of separate additional information of the one or more buffers that includes error information, time out information or storage device malfunctioning information.

3. The apparatus of claim 1, comprising the storage device arranged to access the one or more buffers and the tracking table through one or more input/output interfaces at the host computing platform, the one or more input/output interfaces arranged to operate in compliance with the Non-Volatile Memory Express (NVMe) Specification.

4. The apparatus of claim 1, comprising the one or more buffers maintained at the system memory of the host computing platform or maintained at a persistent memory device coupled with the host computing device.

5. The apparatus of claim 4, comprising the persistent memory device includes one or more memory devices capable of storing data structures such that the data structures continue to be accessible after the data structures are created and after power is restored to the one or more memory devices following a power loss to the one or more memory devices.

6. The apparatus of claim 5, the one or more memory devices maintained on at least one dual in-line memory module (DIMM) coupled with the host computing platform.

7. The apparatus of claim 1, comprising the storage device including one or more storage memory devices having chips or dies that may individually include one or more types of non-volatile memory including at least one of a phase change memory that uses chalcogenide phase change material, flash memory, ferroelectric memory, silicon-oxide-nitride-oxide-silicon (SONOS) memory, polymer memory, ferroelectric polymer memory, ferroelectric transistor random access memory (FeTRAM or FeRAM), ovonic memory, nanowire, electrically erasable programmable read-only memory (EEPROM), phase change memory, memristors or spin transfer torque-magnetoresistive random access memory (STT-MRAM).

8. A method comprising:
receiving, at a controller for a storage device, a write request having a no interrupt response to a storage device driver at a host computing platform coupled with the storage device, the write request indicating a buffer location among one or more buffers having information for a write command to store data to be copied from the one or more buffers;
causing the data to be stored to the storage device based, at least in part, on the information for the write command; and
updating a tracking table maintained at system memory of the host computing platform, the tracking table located in the system memory based on the information for the write command, the updating including indicating a separate status of the one or more buffers that provides an indication of whether the data has been copied to the storage device.

9. The method of claim 8, updating the tracking table further comprising the updating including indicating separate additional information of the one or more buffers including error information, time out information or storage device malfunctioning information.

10. The method of claim 8, comprising the storage device arranged to access the one or more buffers and the tracking table through one or more input/output interfaces at the host computing platform, the one or more input/output interfaces arranged to operate in compliance with the Non-Volatile Memory Express (NVMe) Specification.

11. The method of claim 8, comprising the one or more buffers maintained at the system memory of the host computing platform or maintained at a persistent memory device coupled with the host computing device.

12. The method of claim 11, comprising the persistent memory device including one or more memory devices capable of storing data structures such that the data structures continue to be accessible after the data structures are created and after power is restored to the one or more memory devices following a power loss to the one or more memory devices.

13. A method comprising:
receiving, at a processor circuit for a host computing platform, a write request to store data to one or more storage devices coupled with the host computing platform;
causing the data to be copied to one or more buffers maintained in system memory of the host computing platform or maintained at a persistent memory device coupled with the host computing platform, including information for a write command with the data to be copied to the one or more buffers, the information for the write command including a location of a tracking table maintained in the system memory;
updating the tracking table to include pointers to the one or more buffers and indicate a separate status of the one or more buffers related to use of the one or more buffers for storing the data to the one or more storage devices;
sending an indication of completion of the write request to a requestor of the write request; and
sending a storage write request to one or more storage devices, the storage write request having a no interrupt response to the host computing platform by the one or more storage devices, the storage write request including an indication of a buffer location among the one or more buffers for accessing the information for the write command, the one or more storage devices to use the information for the write command to locate the tracking table in the system memory and update the tracking table by changing the separate status of the one or more buffers to indicate storing of the data to respective one or more storage devices has been completed.

14. The method of claim 13, updating the tracking table to indicate the separate status of the one or more buffers includes the separate status indicating the one or more buffers are being used to store the data to the one or more storage devices.

15. The method of claim 14, changing the separate status of the one or more buffers includes the one or more storage devices to change the separate status of the one or more buffers from a respective used status to a respective ready to be free status to indicate storing of the data to respective one or more storage devices has been completed.

16. The method of claim 15, comprising polling the tracking table at a configurable frequency or upon receiving a second write request to determine whether the separate status of the one or buffers have been changed from the respective used status to the respective ready to be free status to verify that the storing of the data to the respective one or more storage devices has been completed.

17. The method of claim 13, comprising:
the write request to store data to the one or more storage devices sent from an application hosted by the host computing platform, the application arranged to permit volatile caching of the data prior to storage to the one or more storage devices; and
causing the data to be copied to one or more buffers maintained in the system memory of the host computing platform.

18. The method of claim 13, comprising:
the write request to store data to the one or more storage devices sent from an application hosted by the host computing platform, the application arranged to not permit volatile caching of the data prior to storage to the one or more storage devices; and
causing the data to be copied to one or more buffers maintained in the persistent memory device coupled with the host computing platform.

19. The method of claim 13, comprising the persistent memory device including one or more memory devices capable of storing data structures such that the data structures continue to be accessible after the data structures are created and after power is restored to the one or more memory devices following a power loss to the one or more memory devices.

20. At least one machine readable medium comprising a plurality of instructions that in response to being executed by a system at a host computing platform cause the system to:
receive a write request to store data to one or more storage devices coupled with the host computing platform;
cause the data to be copied to one or more buffers maintained in system memory of the host computing platform or maintained at a persistent memory device coupled with the host computing platform, including information for a write command with the data to be copied to the one or more buffers, the information for the write command including a location of a tracking table maintained in the system memory;
update the tracking table to include pointers to the one or more buffers and indicate a separate status of the one or more buffers related to use of the one or more buffers for storing the data to the one or more storage devices;
send an indication of completion of the write request to a requestor of the write request; and
send a storage write request to one or more storage devices, the storage write request having a no interrupt response to the host computing platform by the one or more storage devices, the storage write request to include an indication of a buffer location among the one or more buffers to access the information for the write command, the one or more storage devices to use the information for the write command to locate the tracking table in the system memory and update the tracking table by changing the separate status of the one or more buffers to indicate storing of the data to respective one or more storage devices has been completed.

21. The at least one machine readable medium of claim 20, the instructions to cause the system to update the tracking table further cause the system to indicate the one or more buffers are being used to store the data to the one or more storage devices.

22. The at least one machine readable medium of claim 21, the one or more storage devices to change the separate status of the one or more buffers includes the one or more storage devices to change the separate status of the one or more buffers from a respective used status to a respective ready to be free status to indicate storing of the data to respective one or more storage devices has been completed.

23. The at least one machine readable medium of claim 22, comprising the instructions to further cause the system to:
poll the tracking table at a configurable frequency or upon receiving a second write request to determine whether the separate status of the one or buffers have been changed from the respective used status to the respective ready to be free status to verify that the storing of the data to the respective one or more storage devices has been completed.

24. The at least one machine readable medium of claim 20, comprising the persistent memory device to include one or more memory devices capable of storing data structures such that the data structures continue to be accessible after the data structures are created and after power is restored to the one or more memory devices following a power loss to the one or more memory devices.

25. The at least one machine readable medium of claim 24, the one or more memory devices maintained on at least one dual in-line memory module (DIMM) coupled with the host computing platform.

26. The at least one machine readable medium of claim 24, wherein the one or more memory devices include volatile or non-volatile memory, the volatile memory including random-access memory (RAM), dynamic RAM (D-RAM), double data rate synchronous dynamic RAM (DDR SDRAM), static random-access memory (SRAM), thyristor RAM (T-RAM) or zero-capacitor RAM (Z-RAM) and the non-volatile memory including phase change memory that uses chalcogenide phase change material, flash memory, ferroelectric memory, silicon-oxide-nitride-oxide-silicon (SONOS) memory, polymer memory, ferroelectric polymer memory, ferroelectric transistor random access memory (FeTRAM or FeRAM), ovonic memory, nanowire, electrically erasable programmable read-only memory (EEPROM), phase change memory, memristors or spin transfer torque-magnetoresistive random access memory (STT-MRAM).
